(19) United States
(12) Patent Application Publication
(10) Pub. No.: US 2026/0221473 A1
(43) Pub. Date: Jul. 30, 2026

(54) END CELL HEATER FOR FUEL CELL

(71) Applicants: HYUNDAI MOTOR COMPANY, Seoul (KR); Kia Corporation, Seoul (KR); Hanon Systems, Daejeon (KR)

(72) Inventors: Kil Sang JANG, Daejeon (KR); Yong Ha CHAE, Daejeon (KR)

(73) Assignees: HYUNDAI MOTOR COMPANY, Seoul (KR); Kia Corporation, Seoul (KR); Hanon Systems, Daejeon (KR)

(21) Appl. No.: 19/146,180

(22) PCT Filed: Jan. 2, 2024
(86) PCT No.: PCT/KR2024/000026

§ 371 Date: Jul. 7, 2025

(30) Foreign Application Priority Data
Feb. 27, 2023 (KR) 10-2023-0025691

(51) Int. Cl. H01M 8/04007; H01M 8/0202; H01M 8/2465

(52) U.S. Cl. CPC H01M 8/04074; H01M 8/0269; H01M 8/2465

(57) ABSTRACT

Disclosed is an end cell heater for a fuel cell, including a heater plate formed with a first electrode terminal and a sealing groove, a heating element formed with a second electrode terminal, a guide member coupled to the heating element, and a sealing member interposed between a side wall of the sealing groove and a side wall of the guide member and sealing a space therebetween, so that coolant or water can be definitely prevented from flowing into an electrical connecting portion between a heating element and an electrode terminal, thereby improving the safe insulation and reliable durability of the fuel cell.

### TECHNICAL FIELD

The disclosure relates to an end cell heater for a fuel cell, and more specifically to an end cell heater for a fuel cell, which has a waterproof structure in an electrical connecting portion between a heating element of an end cell heater and an electrode terminal.

### BACKGROUND ART

In general, a fuel cell refers to a power generation device that converts chemical energy based on oxidation and reduction of hydrogen into electrical energy, and is being spotlighted as the next-generation alternative energy source because it expels only water as a byproduct, produces almost no NOx, SOx and dust, reduces carbon dioxide emissions, and make little noise, unlike other existing chemical energies.

The fuel cell includes unit cells basically including an electrolyte plate containing an electrolyte, an anode, a cathode, and a separator separating the electrolyte plate, the anode, and the cathode from one another. However, the unit cell generally generates a low voltage of 0.6 to 0.8V, and thus several tens or several hundreds of unit cells 30 are stacked as shown in FIG. 1 to make up a fuel cell stack 1 for a desired electric output.

In the fuel cell where the unit cells are stacked as above, water produced by the combination of hydrogen and oxygen remains on a unit cell located at the outermost side in a stacking direction (i.e., an end cell), and an end cell heater for heating the end cell is provided to prevent water from freezing inside the end cell due to cold outside air in winter. Besides, coolant is used in the end cell to cool down because heat is generated by reaction.

However, coolant, water, etc. in the end cell may flow into an electrical connecting portion between a heating element of the end cell heater and a connector terminal, and conduct electricity between the heating element of the end cell heater and a collector plate of the end cell, thereby causing problems such as insulation breakdown of the heating element, a short circuit, a spark, or damage to the heating element.

### DOCUMENTS OF RELATED ART

### Patent Document

KR 10-2261535 B1 (Jun. 1, 2021)

### DISCLOSURE

### Technical Problem

The disclosure has been conceived to solve the foregoing problems, and an aspect of the disclosure is to provide an end cell heater for a fuel cell, which has a definite waterproof structure to prevent coolant or water from flowing into an electrical connecting portion between a heating element of the end cell heater and an electrode terminal.

### Technical Solution

According to an embodiment of the disclosure, an end cell heater for the fuel cell includes: a heater plate including a sealing groove formed concavely, and a first electrode terminal formed to be exposed to an interior of the sealing groove; a heating element stacked on one surface of the heater plate in a thickness direction, and including a second electrode terminal coupled corresponding to the first electrode terminal; a guide member coupled to the heating element, formed surrounding outer sides of the first electrode terminal and the second electrode terminal, and including a side wall to be inserted in the sealing groove of the heater plate; and a sealing member inserted into the sealing groove of the heater plate, and interposed between a side wall of the sealing groove and the side wall of the guide member.

Further, the sealing member may be formed of an elastic material, and the sealing member may be pressed against and in close contact with the side wall of the sealing groove and the side wall of the guide member in a direction where the side wall of the sealing groove and the side wall of the guide member face each other.

Further, the sealing member may be pressed against and in close contact with the side wall of the guide member in a direction perpendicular to a direction where the side wall of the guide member is inserted into the sealing groove.

Further, the sealing member may include a body, and a sealing protrusion formed protruding from the body toward the side wall of the guide member.

Further, the sealing protrusion may include a plurality of sealing protrusions, and the plurality of sealing protrusions may be arranged to be spaced apart from each other in a depth direction of the sealing groove.

Further, the body of the sealing member may be formed to have a width smaller than a distance between the side wall of the sealing groove and the side wall of the guide member, and an overall width of the sealing member including the body and the sealing protrusion may be larger than the distance between the side wall of the sealing groove and the side wall of the guide member.

Further, the sealing member may include a locking portion formed extending outwardly from the body, and the heater plate may include a locking groove formed on an outer side of the sealing groove and corresponding to the locking portion of the sealing member.

Further, the guide member may include a locking hook formed outwardly from an upper end of the side wall thereof, and the heater plate may include a locking hole formed on an outer side of the sealing groove and corresponding to the locking hook of the guide member.

Further, the locking hook may include a first horizontal portion formed extending outwardly from the upper end of the side wall of the guide member, a first vertical portion formed extending downwardly from an end of the first horizontal portion, and a second horizontal portion formed extending outwardly from the first vertical portion.

Further, a lower end of the side wall of the guide member may be spaced apart from a bottom of the sealing groove of the heater plate.

Further, the guide member may include a partition wall formed connecting first and second sides of an inner circumferential surface of the side wall.

Further, the end cell heater may additionally include a collector plate stacked on one surface of the heating element in a thickness direction, being in surface contact with the heating element, and coupled to the heater plate, wherein the heating element is spaced apart from the collector plate in an area where the guide member is present

### Advantageous Effects

In an end cell heater for a fuel cell according to the disclosure, a heating element is prevented from insulation breakdown, and a short circuit is thus prevented between the heating element and a collector plate, thereby having advantages of improving the safe insulation and reliable durability of the fuel cell.

### DESCRIPTION OF DRAWINGS

FIG. 1 is a perspective view of a conventional fuel cell.

FIGS. 2 and 3 are assembled and exploded perspective views of an end cell heater for a fuel cell according to an embodiment of the disclosure.

FIGS. 4 and 5 are exploded and assembled cross-sectional views of an end cell heater for a fuel cell according to an embodiment of the disclosure.

FIG. 6 is a cross-sectional view of a securing structure for a sealing member in an end cell heater for a fuel cell according to an embodiment of the disclosure.

FIG. 7 is a cross-sectional view of a securing structure for a guide member of an end cell heater for a fuel cell according to an embodiment of the disclosure.

FIGS. 8 and 9 are exploded and assembled perspective views of a fuel cell including an end cell heater for the fuel cell according to an embodiment of the disclosure.

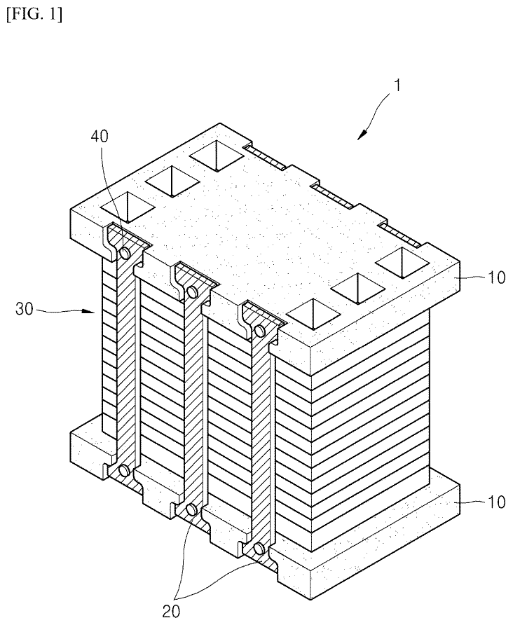

### MODE FOR INVENTION

Below, an end cell heater for a fuel cell according to the disclosure with the foregoing configurations will be described in detail with reference to the accompanying drawings.

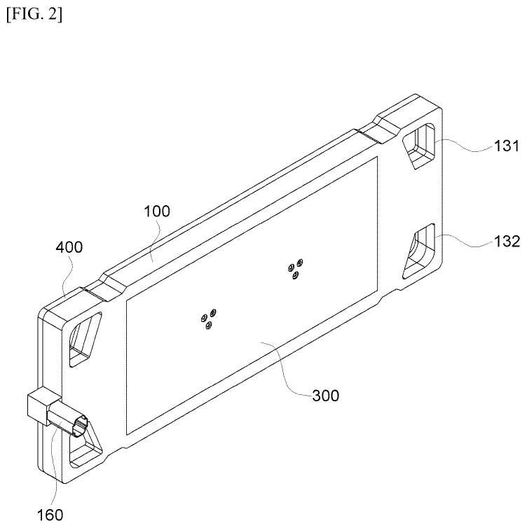

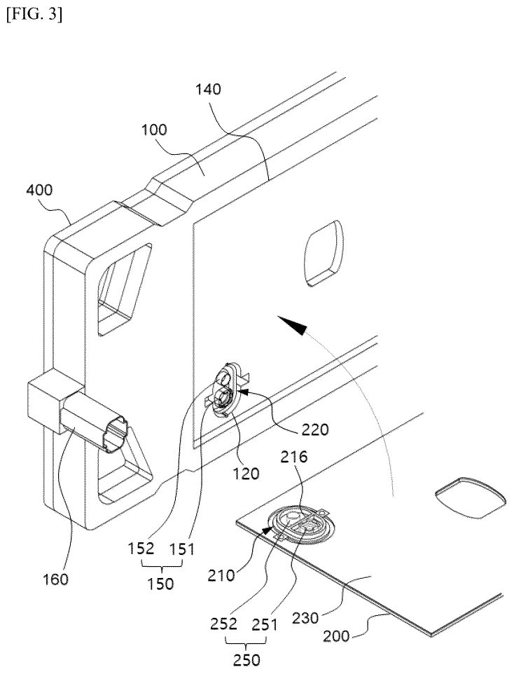

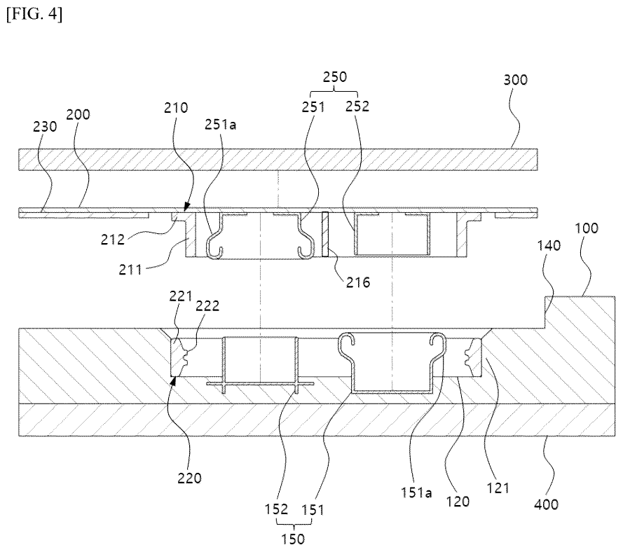

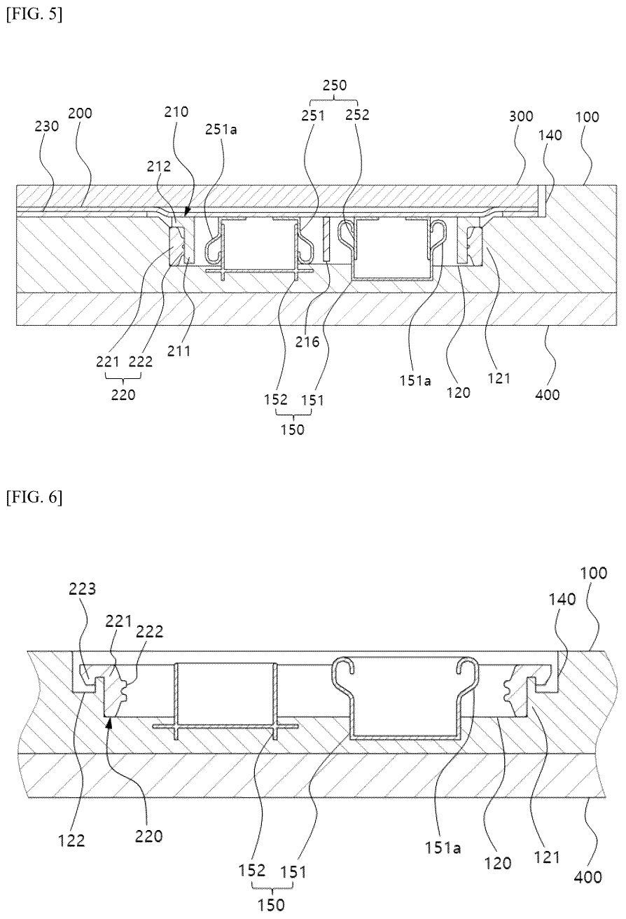

FIGS. 2 and 3 are assembled and exploded perspective views of an end cell heater for a fuel cell according to an embodiment of the disclosure, and FIGS. 4 and 5 are exploded and assembled cross-sectional views of an end cell heater for a fuel cell according to an embodiment of the disclosure.

As shown therein, an end cell heater 1000 for a fuel cell according to an embodiment of the disclosure may broadly include a heater plate 100, a first electrode terminal 150, a heating element 200, a second electrode terminal 250, a guide member 210, and a sealing member 220. In addition, the end cell heater for the fuel cell according to the disclosure may further include a collector plate 300, and may still further include a sealing pad 230, and an end plate 400.

The heater plate 100 may serve as a housing to which the heating element 200 is mounted, and may be formed of an electrically insulating plastic material. The heater plate 100 may be shaped like a substantially rectangular plate, and may be formed with a mounting groove 140 recessed downward on one side in a thickness direction. The heating element 200 may be inserted in the mounting groove 140. Within an area of the heater plate 100 where the mounting groove 140 is formed, a sealing groove 120 may be recessed downward from the mounting groove 140. In addition, a pair of first electrode terminals 150 may be formed protruding from the bottom of the sealing groove 120 toward the interior of the sealing groove 120, so that the pair of first electrode terminals 150 can be exposed to the interior of the sealing groove 120. Further, an air passage 131 and a fuel passage 132 may be formed on opposite sides in the longitudinal direction of the heater plate 100 and penetrating both surfaces in the thickness direction. Although not shown, coolant channels may be additionally formed on opposite sides in the longitudinal direction of the heater plate 100 and penetrating both surfaces in the thickness direction. Further, the heater plate 100 may be formed integrally with a connector 160. The first electrode terminal 150 may be provided as a pair and may be placed inside the sealing groove 120 of the heater plate 100. In addition, the first electrode terminal 150 may be coupled and secured to the heater plate 100, and the first electrode terminal 150 may be electrically connected to the connector 160. Further, the first electrode terminal 150 may be exposed to one surface of the heater plate 100 in the thickness direction. For example, the first electrode terminal 150 may be formed of a metal material and the heater plate 100 may be formed of a non-conductive plastic material, in which the first electrode terminal 150 and the heater plate 100 may be integrally formed by insert injection. Besides, the first electrode terminal 150 may be coupled to the heater plate 100 in various shapes and various ways.

The heating element 200 may generate heat by receiving electricity, and may be, for example, a film heater shaped like a thin plate. The heating element 200 may be stacked on one surface of the heater plate 100 in the thickness direction, and the heating element 200 may be inserted into the mounting groove 140 of the heater plate 100. The second electrode terminal 250 may be provided as a pair and may be coupled and secured to the heating element 200, in which the second electrode terminals 250 may be electrically connected to the heating element 200. In addition, the second electrode terminal 250 may be placed at a position corresponding to the first electrode terminal 150, and the second electrode terminal 250 may be shaped corresponding to the first electrode terminal 150. For example, the second electrode terminal 250 may be formed integrally with the heating element 200. Further, the second electrode terminal 250 may be elastically fitted and coupled to the first electrode terminal 150. In other words, the second electrode terminal 250 is press-fitted into the first electrode terminal 150, so that the second electrode terminal 250 can be put on or inserted in and thus elastically coupled to the first electrode terminal 150, thereby firmly coupling the second electrode terminal 250 and the first electrode terminal 150 not to be easily separated in the opposite direction to the press-fitting direction when coupled to each other.

The guide member 210 may be coupled to the heating element 200. For example, the guide member 210 may be adhered and secured to the heating element 200. The guide member 210 may be formed to entirely surround the outer sides of the pair of first electrode terminals 150 and the pair of second electrode terminals 250, and may include a side wall 211 of the guide member 210 to be inserted in the sealing groove 120 of the heater plate 100. Here, the outer surface of the side wall 211 of the guide member 210 may be spaced apart from the inner surface of a side wall 121 of the sealing groove 120.

The sealing member 220 may be formed of an elastic material, be inserted into the sealing groove 120 of the heater plate 100, and have an outer surface to come into contact with the side wall 121 of the sealing groove 120. In addition, the sealing member 220 is formed to entirely surround the outer sides of the pair of first electrode terminals 150 and the pair of second electrode terminals 250, and the sealing member 220 may be placed between the side wall 121 of the sealing groove 120 and the side wall 211 of the guide member 210. Thus, when the guide member 210 is inserted into the sealing groove 120 in the assembled state of the sealing member 220 inserted into the sealing groove 120, the side wall 211 of the guide member 210 is inserted while coming into contact with the inner side of the sealing member 220 so that the sealing member 220 can be pressed between and be in close contact with the side wall 121 of the sealing groove 120 and the side wall 211 of the guide member 210. In other words, the sealing member 220 is pressed in a lateral direction perpendicular to the thickness direction in which the side wall 211 of the guide member 210 is inserted into the sealing groove 120, thereby sealing a space between the side wall 211 of the guide member 210 and the side wall 121 of the sealing groove 120. In this case, the position of the second electrode terminal 250 formed on the heating element 200 is guided by the guide member 210, so that the first electrode terminal 150 and the second electrode terminal 250 can be coupled to each other at a correct position.

Thus, water, coolant, etc. may not flow into the sealing groove 120, where the first electrode terminal 150 and the second electrode terminal 250 to be electrically connected are arranged. In addition, the first electrode terminal 150 and the second electrode terminal 250 are firmly and elastically coupled by fitting to each other, thereby preventing the first electrode terminal 150 and the second electrode terminal 250 from being separated from each other by the repulsive force caused by the elasticity of the sealing member 220. Further, even though the heating element 200 and the guide member 210 are not pressed toward the heater plate 100 in the thickness direction, the guide member 210 may not be separated by the elasticity of the sealing member 220, and a degree of close contact with the sealing member 220 may be maintained at a constant level. Accordingly, the insulation breakdown of the heating element may be prevented, a short circuit between the heating element and the collector plate may be prevented, and the safe insulation and reliable durability of the fuel cell may be improved.

Further, the sealing member 220 may include a body 221 shaped like a ring, and a sealing protrusion 222 formed to protrude inwardly from the body 221. The sealing protrusion 222 may be formed protruding from the body 221 toward the side wall 211 of the guide member 210, and the sealing protrusion 222 may be formed continuously along the body 221 throughout the body 221. The sealing protrusion 222 may be formed in plural, and the plurality of sealing protrusions 222 may be arranged to be spaced apart from each other in the thickness direction. Thus, when the side wall 211 of the guide member 210 is inserted into the interior of the sealing member 220, the guide member 210 may be inserted while compressing and deforming the sealing protrusions 222, thereby facilitating the assembly.

Further, the body 221 of the sealing member 220 may be formed to have a width smaller than a distance between the side wall 121 of the sealing groove 120 and the side wall 211 of the guide member 210, and the overall width of the sealing member 220 including the body 221 and the sealing protrusion 222 may be larger than the distance between the side wall 121 of the sealing groove 120 and the side wall 211 of the guide member 210. Accordingly, a space where the sealing protrusion 222 may be compressed and deformed may be secured, and the guide member 210 may also be easily inserted into the interior of the sealing member 220.

FIG. 6 is a cross-sectional view of a securing structure for a sealing member in an end cell heater for a fuel cell according to an embodiment of the disclosure.

As shown therein, a locking groove 122 may be formed concavely on the outer side of the sealing groove 120 while being connected to the sealing groove 120 of the heater plate 100, and a locking portion 223 is formed extending outwardly from the body 221 of the sealing member 220 and shaped like a hook, so that the locking portion 223 of the sealing member 220 can be hooked and coupled to the locking groove 122 of the heater plate 100. Thus, the sealing member 220 can be secured in the correct position while being inserted in the sealing groove 120, and prevented from separation.

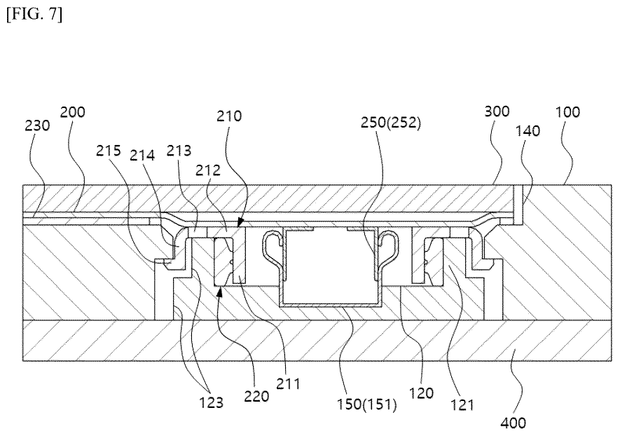

FIG. 7 is a cross-sectional view of a securing structure for a guide member of an end cell heater for a fuel cell according to an embodiment of the disclosure.

As shown therein, the guide member 210 may include the side wall 211 and a flange 212, and may further include a locking hook. The side wall 211 of the guide member 210 may be formed in a ring or cylinder shape, and the flange 212 may extend outwardly from the upper end of the side wall 211. In addition, the guide member 210 may for example have a pair of locking hooks extending outwardly from the flange 212, and the locking hook may include a first horizontal portion 213 formed extending outwardly from the flange 212, a first vertical portion 214 formed extending downwardly from the end of the first horizontal portion 213, and a second horizontal portion 215 formed extending outwardly from the end of the first vertical portion 214. Further, a locking hole 123 is formed corresponding to the locking hook of the guide member 210 on the outer side of the sealing groove 120 of the heater plate 100, so that the locking hook can be inserted in and hooked to the locking hole 123. Here, the positions, shapes, etc. of the locking hook and the locking hole 123 may be formed in various ways.

Further, the lower end of the side wall 211 of the guide member 210 may be spaced apart from the bottom of the sealing groove 120 of the heater plate 100. In this case, the lower surface of the flange 212 of the guide member 210 may be supported on and in contact with the upper end of the body 221 of the sealing member 220, and the lower end of the body 221 of the sealing member 220 may be supported on and in contact with the bottom of the sealing groove 120. Thus, when the guide member 210 is inserted in the sealing groove 120, the locking hook of the guide member 210 may be easily hooked and coupled to the locking hole 123 as the body 221 of the sealing member 220 is pressed.

Further, the guide member 210 may be formed with a partition wall 216 connecting first and second sides of the inner circumferential surface of the side wall 211. For example, the partition wall 216 may be placed between the neighboring second electrode terminals 250. Thus, the partition wall 216 may prevent the side wall 211 from deformation, and separate the neighboring second electrode terminals 250 from each other to thereby improve electrical insulation.

Further, the end cell heater for the fuel cell according to the disclosure may further include the collector plate 300 stacked on one surface of the heating element 200 in the thickness direction, being in surface contact with the heating element 200, and coupled to the heater plate 100. The collector plate 300 is to collect and transmit electricity generated in the fuel cell stack, and may be formed of an electrically conductive material, i.e., a metal plate. In addition, a pair of collector terminals 310 may be formed protruding from the collector plate 300. For example, the heater plate 100 and the heating element 200 may have through holes formed penetrating both surfaces in the thickness direction at positions corresponding to the collector terminals 310, and the collector plate 300 may be stacked on one surface of the heating element 200 in the thickness direction, and the collector plate 300 may be inserted into the mounting groove 140 formed on the heater plate 100. In this case, the collector terminals 310 may pass through the through holes formed in the heater plate 100 and the heating element 200, so that the free ends of the collector terminals 310 can protrude toward the other surface of the heater plate 100 in the thickness direction. Thus, when the collector plate 300 is coupled to the heater plate 100, the heating element 200 may be pressed against the heater plate 100. Here, in an area where the guide member 210 is placed, the heating element 200 may be spaced apart from the collector plate 300. In other words, a gap may be formed between the heating element 200 and the collector plate 300 in the area where the guide member 210 is present. Thus, when the collector plate 300 is fastened to the heater plate 100 or when the end cell heater for the fuel cell is coupled and fastened to the fuel cell stack, fastening force may not be transmitted to the guide member 210. Therefore, the sealing force of the sealing member 220 may not change, thereby improving the watertightness.

Further, the sealing pad 230 may be formed on the surface of the heater plate 100 facing the heating element 200, and the sealing pad 230 may be formed integrally with the heating element 200. Thus, a space between the heating element 200 and the heater plate 100 may be sealed by the sealing pad 230.

Further, for example, one of the pair of first electrode terminals 150 may be a first socket 151 formed with a plurality of elastic protrusions 151a, and the other may be a first sleeve 152. In addition, one of the pair of second electrode terminals 250 may be a second sleeve 252 inserted in and coupled to the first socket 151, and the other may be a second socket 251 formed with a plurality of elastic protrusions 251a, and the other may be the first sleeve 152 inserted and coupled into the first sleeve 152. Here, an inner diameter connecting the inner sides of the elastic protrusions 151a formed in the first socket 151 may be formed smaller than an outer diameter of the second sleeve 252, so that the second sleeve 252 can be firmly coupled to the first socket 151 by the elastic protrusions 151a when the second sleeve 252 is inserted into the first socket 151. Likewise, an inner diameter connecting the inner sides of the elastic protrusions 251a formed in the second socket 251 may be formed smaller than an outer diameter of the first sleeve 152, so that the first sleeve 152 can be firmly connected to the second socket 251 by the elastic protrusions 251a when the first sleeve 152 is inserted into the second socket 251.

Further, the end cell heater for the fuel cell according to an embodiment of the disclosure may further include an end plate 400 stacked on the other surface of the heater plate 100 in the thickness direction. The end plate 400 may be formed with an air channel through which air flows and a fuel channel through which fuel flows, and thus an air passage communicating with the air channel and a fuel passage communicating with the fuel channel may be formed.

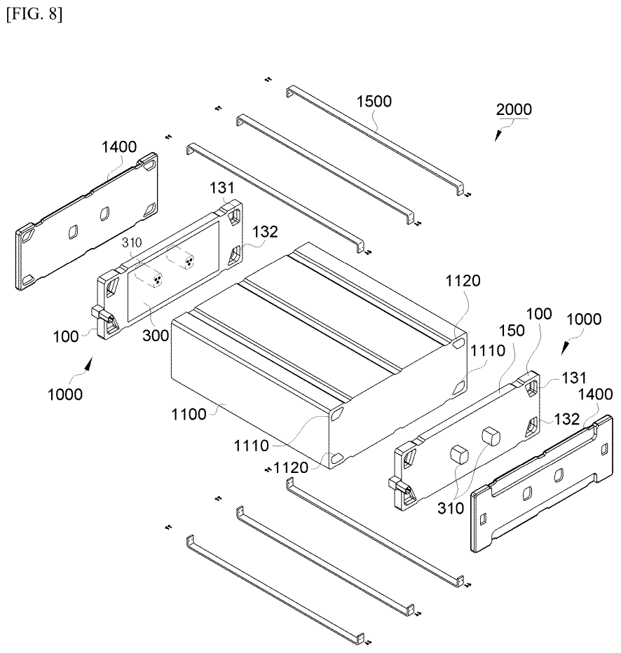

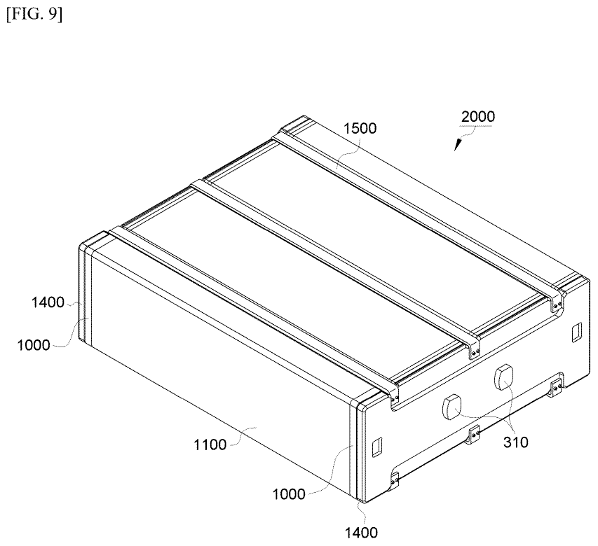

FIGS. 8 and 9 are exploded and assembled perspective views of a fuel cell including an end cell heater for the fuel cell according to an embodiment of the disclosure.

As shown therein, a fuel cell 2000 according to the disclosure may include a fuel cell stack 1100 formed by stacking unit cells and formed with air passages 1110 and fuel passages 1120 penetrating both surfaces in the stacking direction on both sides; and an end cell heater 1000 coupled to the fuel cell stack 1100 and stacked on the outer side of the unit cell arranged at the outermost end among the unit cells to connect the passages.

In other words, the fuel cell 2000 may be formed by stacking the end cell heater 1000 on the fuel cell stack 1100 formed by stacking reaction cells, and the end cell heater 1000 may be stacked on and come into close contact with the reaction cells stacked on the outermost side of the fuel cell stack 1100 in the same direction as the stacking direction. In this case, the air passage 1110 and the fuel passage 1120 formed in the fuel cell stack 1100 may be connected to the corresponding air passage 131 and the corresponding fuel passage 132 of the end cell heater 1000. In this case, the fuel cell stack 1100 may be formed with a cooling passage between the air passage 1110 and the fuel passage 1120, so that a heat exchange medium (refrigerant) can pass through the unit cells to cool the unit cells.

Therefore, the end cell heaters may be installed on the fuel cell stack only by stacking the end cell heaters on the outer sides of the outermost reaction cells, like stacking the unit cells making up the fuel cell stack, and coupling the end cell heaters to the outermost reaction cells so as to be in close contact with the outermost reaction cells, and a structure for connecting the passages to each other is so simple that the end cell heaters can be very easily installed. In addition, the end cell heaters may be used as described above to prevent water inside the end cells of the fuel cell stack from being frozen, thereby improving the initial start ability and initial driving performance of the fuel cell.

Further, there may be additionally provided a cover 1400 made of an electrically insulating material, stacked on the outer side where the end cell heater 1000 is stacked, and formed to expose the collector terminal 310 of the end cell heater 1000 to the outside. In addition, there may be additionally provided a fastening member 1500, both ends of which are coupled to the covers 1400. In other words, the covers 1400 made of an insulating material are respectively arranged on the outer sides of the two end cell heaters 1000 in the thickness direction, which are arranged to be stacked on both sides of the fuel cell stack 1100 in the thickness direction, and the fastening members 1500 are used such that the two covers 1400, the two end cell heaters 1000, and the fuel cell stack 1100 can be coupled and secured to be in close contact with one another in the stacking direction.

The disclosure is not limited to the foregoing embodiments, but may be variously applied. In addition, the disclosure may be variously modified by those skilled in the art to which the disclosure pertains without departing from the gist of the disclosure claimed in the claims.

[Reference Numerals]

| | |
|---|---|
| 1000: end cell heater for the fuel cell | |
| 100: heater plate | |
| 120: sealing groove | 121: side wall |
| 122: locking groove | 123: locking hole |
| 131: air passage | |
| 132: fuel passage | 140: mounting groove |
| 150: first electrode terminal | 151: first socket |
| 151a: elastic protrusion | 152: first sleeve |
| 160: connector | |
| 200: heating element | 210: guide member |
| 211: side wall | 212: flange |
| 213: first horizontal portion | 214: first vertical portion |
| 215: second horizontal portion | 216: partition wall |
| 220: sealing member | 221: body |
| 222: sealing protrusion | 223: locking portion |
| 230: sealing pad | |
| 250: second electrode terminal | 251: second socket |
| 251a: elastic protrusion | 252: second sleeve |
| 300: collector plate | 310: collector terminal |
| 400: end plate | |
| 2000: fuel cell | |
| 1100: fuel cell stack | |
| 1110: air passage | 1120: fuel passage |
| 1400: cover | 1500: fastening member |

1. An end cell heater for the fuel cell, comprising:
a heater plate comprising a sealing groove formed concavely, and a first electrode terminal formed to be exposed to an interior of the sealing groove;
a heating element stacked on one surface of the heater plate in a thickness direction, and comprising a second electrode terminal coupled corresponding to the first electrode terminal;
a guide member coupled to the heating element, formed surrounding outer sides of the first electrode terminal and the second electrode terminal, and comprising a side wall to be inserted in the sealing groove of the heater plate; and
a sealing member inserted into the sealing groove of the heater plate, and interposed between a side wall of the sealing groove and a side wall of the guide member.

2. The end cell heater of claim 1, wherein the sealing member is formed of an elastic material, and the sealing member is pressed against and in close contact with the side wall of the sealing groove and the side wall of the guide member in a direction where the side wall of the sealing groove and the side wall of the guide member face each other.

3. The end cell heater of claim 2, wherein the sealing member is pressed against and in close contact with the side wall of the guide member in a direction perpendicular to a direction where the side wall of the guide member is inserted into the sealing groove.

4. The end cell heater of claim 2, wherein the sealing member comprises a body, and a sealing protrusion formed protruding from the body toward the side wall of the guide member.

5. The end cell heater of claim 4, wherein the sealing protrusion comprises a plurality of sealing protrusions, and the plurality of sealing protrusions are arranged to be spaced apart from each other in a depth direction of the sealing groove.

6. The end cell heater of claim 4, wherein
the body of the sealing member is formed to have a width smaller than a distance between the side wall of the sealing groove and the side wall of the guide member, and
an overall width of the sealing member comprising the body and the sealing protrusion is larger than the distance between the side wall of the sealing groove and the side wall of the guide member.

7. The end cell heater of claim 1, wherein the sealing member comprises a locking portion formed extending outwardly from the body, and the heater plate comprises a locking groove formed on an outer side of the sealing groove and corresponding to the locking portion of the sealing member.

8. The end cell heater of claim 1, wherein the guide member comprises a locking hook formed outwardly from an upper end of the side wall thereof, and the heater plate comprises a locking hole formed on an outer side of the sealing groove and corresponding to the locking hook of the guide member.

9. The end cell heater of claim 8, wherein the locking hook comprises a first horizontal portion formed extending outwardly from the upper end of the side wall of the guide member, a first vertical portion formed extending downwardly from an end of the first horizontal portion, and a second horizontal portion formed extending outwardly from the first vertical portion.

10. The end cell heater of claim 1, wherein a lower end of the side wall of the guide member is spaced apart from a bottom of the sealing groove of the heater plate.

11. The end cell heater of claim 1, wherein the guide member comprises a partition wall formed connecting first and second sides of an inner circumferential surface of the side wall.

12. The end cell heater of claim 1, further comprising a collector plate stacked on one surface of the heating element in a thickness direction, being in surface contact with the heating element, and coupled to the heater plate, wherein the heating element is spaced apart from the collector plate in an area where the guide member is present.

13. The end cell heater of claim 1, wherein
the guide member further comprises a flange formed extending outwardly from an upper end of the side wall, and
a lower surface of the flange is supported on and in contact with an upper end of a body of the sealing member.

14. The end cell heater of claim 13, wherein a lower end of the body of the sealing member is supported on and in contact with a bottom of the sealing groove.

15. The end cell heater of claim 1, wherein a sealing pad is formed on a surface of the heating element facing the heater plate.

16. The end cell heater of claim 1, wherein the first electrode terminal and the second electrode terminal are elastically coupled by fitting to each other.

17. The end cell heater of claim 16, wherein
the first electrode terminals are provided as a pair and the second electrode terminals are provided as a pair,
one of the pair of first electrode terminals is a first socket formed with a plurality of elastic protrusions and the other is a first sleeve, and
one of the pair of second electrode terminals is a second sleeve inserted in and coupled to the first socket and the other is a second socket inserted in and coupled to the first sleeve and formed with a plurality of elastic protrusions.

18. The end cell heater of claim 17, wherein
an inner diameter connecting inner sides of the plurality of elastic protrusions formed in the first socket is formed smaller than an outer diameter of the second sleeve, and
an inner diameter connecting inner sides of the plurality of elastic protrusions formed in the second socket is formed smaller than an outer diameter of the first sleeve.
